(19) United States
(12) Patent Application Publication
(10) Pub. No.: US 2003/0037013 A1
(43) Pub. Date: Feb. 20, 2003

(54) Web site access service providing system

(76) Inventors: Hideyuki Aoki, Kawasaki (JP); Norio Murakami, Kawasaki (JP)

Correspondence Address: Rosenman & Colin LLP, 575 Madison Avenue, New York, NY, 10022-2585, US

(21) Appl. No.: 09/953,694

(22) Filed: Sep. 17, 2001

(30) Foreign Application Priority Data
May 14, 2001 (JP) 2001-143471

(51) Int. Cl. G06F 17/60

(52) U.S. Cl. 705/77

(57) ABSTRACT

A Web site access service control apparatus as a computer system includes a module for transmitting a content menu of a Web site provided by a non-contract common carrier of a user to a communications terminal of the user in response to a request given from the user via the communications terminal, a module for obtaining content data corresponding to the content menu of the non-contract common carrier selected by the user, and transmitting the content data to the communications terminal, a module for transmitting, to the communications terminal of the user, a menu in which the non-contact common carrier is arbitrarily selected corresponding to the contract-common carrier of the user, and a module for converting display data in accordance with an attribute of the communications terminal of the user.

### BACKGROUND OF THE INVENTION

The present invention relates to a Web site access service providing system for making a user of a communications terminal accessible to a Web site administered by a different common carrier via a network (communications network) of an active common carrier with which this user has a contract.

In a conventional information communications network system including a mobile communications network and the Internet, the user of the mobile communications terminal such as a mobile telephone terminal is accessible to the Web site on the Internet which is administered by a mobile common carrier via the network of this carrier but is unable to utilize a Web site provided by a non-contract mobile common carrier.

Further, there might be a case where the user can not have a direct access due to a difference in content expression format between the mobile common carriers. Moreover, even if accessible via an external site, a fee payment is made differently in the great majority of cases, and this procedure is time-consuming.

By the way, one of basic concepts of IMT-2000 (International Mobile Telecommunications 2000) defined as a next generation mobile communications system, is to provide the users with a global space for use.

Individual technological specifications required therefor are schemed to be globalized. For instance, software (generally known as Microbrowser) for browsing information (content data) of the Web site in the Internet on the mobile communications terminal such as the mobile phone terminal and languages for describing the content data, are being standardized. As a result, this leads to establishing a platform (environment) where one single mobile communications terminal can function not only for domestic use but also in other countries.

Even when a new mobile communications environment is created by IMT-2000, the users of the mobile communications terminals need to enter into contracts with the individual common carriers. Further, it is required that each common carrier keeps a service strategy for providing the content data characteristic of only this carrier in the way taken so far in order to ensure the users who enter into the contract and to differentiate the service.

Even when the external environment is established by launching into an IMT-2000 world, it is inevitable that there arises a situation in which the non-contract users are unable to obtain the content data of the Web site provided by other common carrier.

Further, the globalization of the technological specifications based on IMT-2000 contains a contrary base where every user has a possibility of developing fraud services and businesses.

### SUMMARY OF THE INVENTION

It is a primary object of the present invention to provide an apparatus and a method of making a user of a communications terminal accessible to a Web site administered by a different common carrier via a communications network of an active common carrier with which the user of the communications terminal has a contract.

It is another object of the present invention to provide an apparatus and a method capable of preventing developments of fraud services and businesses related to fees for use.

To accomplish the above objects, a first Web site access service control apparatus according to the present invention comprises a module for transmitting a content menu of a Web site provided by a non-contract common carrier of a user to a communications terminal of the user in response to a request given from the user via the communications terminal, and a module for obtaining content data corresponding to the content menu of the non-contract common carrier selected by the user, and transmitting the content data to the communications terminal.

A second Web site access service control apparatus according to the present invention may further comprise a module for transmitting, to the communications terminal of the user, a menu in which the non-contact common carrier is arbitrarily selected corresponding to the contract-common carrier of the user.

A third Web site access service control apparatus according to the present invention may further comprise a module for converting display data in accordance with an attribute of the communications terminal of the user. Herein, the attribute of the communications terminal may be a content expression format.

A fourth Web site access service control apparatus according to the present invention may further comprise a module for making, if accesses to the Web site from the contact common carrier of the user are congested, the user accessible to the same category of Web site administered by the non-contract common carrier in response to a request of the user.

A fifth Web site access service control apparatus according to the present invention may further comprise a module for controlling a settlement of fees for user accesses to the Web site administered by the non-contract common carrier. Herein, the module for controlling the fee settlement may notify the user's contract common carrier of a fee for accessing the Web site administered by the non-contract common carrier, a fee for operations of the non-contract common carrier and a fee for providing a Web site access service, and may make the contract common carrier collect the fees.

A sixth Web site access service control apparatus according to the present invention may further comprise a module for receiving, if the communications terminal is classified as a prepaid card system communications terminal, a piece of balance information corresponding to the communications terminal.

A seventh Web site access service control apparatus according to the present invention may further comprise a module for transmitting, to the communications terminal, balance deficiency information containing an item of re-request that can be made.

A first Web site access service control method according to the present invention comprises transmitting a content menu of a Web site provided by a non-contract common carrier of a user to a communications terminal of the user in response to a request given from the user via the communications terminal, and obtaining content data corresponding to the content menu of the non-contract common carrier selected by the user, and transmitting the content data to the communications terminal.

A second Web site access service control method according to the present invention may further comprise transmitting, to the communications terminal of the user, a menu in which the non-contact common carrier is arbitrarily selected corresponding to the contract-common carrier of the user.

A third Web site access service control method according to the present invention may further comprise converting display data in accordance with an attribute of the communications terminal of the user.

A fourth Web site access service control method according to the present invention may further comprise making, if accesses to the Web site from the contact common carrier of the user are congested, the user accessible to the same category of Web site administered by the non-contract common carrier in response to a request of the user.

A fifth Web site access service control method according to the present invention may further comprise controlling a settlement of fees for user accesses to the Web site administered by the non-contract common carrier.

A sixth Web site access service control method according to the present invention may further comprise notifying the user's contract common carrier of a fee for accessing the Web site administered by the non-contract common carrier, a fee for operations of the non-contract common carrier and a fee for providing a Web site access service in order to make the contract common carrier collect the fees.

A seventh Web site access service control method according to the present invention may further comprise receiving, if the communications terminal is classified as a prepaid card system communications terminal, a piece of balance information corresponding to the communications terminal.

An eighth Web site access service control method according to the present invention may further comprise transmitting, to the communications terminal, balance deficiency information containing an item of re-request that can be made.

The processes (steps) described above according to the present invention are provided as a program executable by a computer. The program may be recorded on a recording medium such as a CD-ROM, a floppy disk and so on, and may also be distributed via a communications line.

According to the present invention, the user of the communication terminal is able to access the content data of the Web site provided by the non-contract common carrier, and a service utilizing range of the users can be expanded.

Further, according to the present invention, a fraudaction related to the fee settlement can be prevented.

### BRIEF DESCRIPTION OF THE DRAWINGS

The foregoing and other features and advantages of the present invention will become more readily appreciated as the same becomes better understood by reference to the following detailed description when taken into conjunction with the accompanying drawings wherein:

FIG. 1 is a block diagram showing an architecture of a Web site access service providing system in one embodiment of the present invention;

FIG. 2 is a block diagram showing an architecture of a computer system in FIG. 1;

FIG. 3 is a diagram showing an operation sequence of a basic Web site access service process;

FIG. 4 is an explanatory diagram showing a sequence of a fee settlement process corresponding to the basic Web site access service process;

FIG. 5 is a flowchart showing whole processes in the computer system;

FIG. 6 is a flowchart showing a request receiving process from a user (contractor) entering into a contract in the computer system;

FIG. 7 is a flowchart showing a carrier menu and content formatting process in the computer system;

FIG. 8 is a flowchart showing a charged-fee collecting process in the computer system;

FIG. 9 is a diagram showing an example of a screen display on a mobile communications terminal during a service operation;

FIG. 10 is a diagram showing an example of a screen display on the mobile communications terminal during the service operation;

FIG. 11 is a diagram various categories of information transmitted and received between each of carriers, the computer system and each of carrier authorized sites;

FIG. 12 is a diagram showing an operation sequence of a prepaid card system mobile communications terminal oriented process;

In FIG. 13 is a diagram showing an operation sequence of the prepaid card system mobile communications terminal oriented process;

FIG. 14 is a diagram showing an operation sequence of the prepaid card system mobile communications terminal oriented process;

FIG. 15 is a diagram showing an operation sequence of the prepaid card system mobile communications terminal oriented process;

FIG. 16 is an explanatory diagram showing a fee payment sequence of a fee settlement process corresponding to the prepaid card system mobile communications terminal oriented process; and

FIG. 17 is a diagram showing an operation sequence of a process executed when a congestion occurs on the authorized site.

### DETAILED DESCRIPTION OF THE PREFERRED EMBODIMENTS

Embodiments of the present invention will hereinafter be discussed with reference to the accompanying drawings.

[Architecture of Web Site Access Service Providing System]

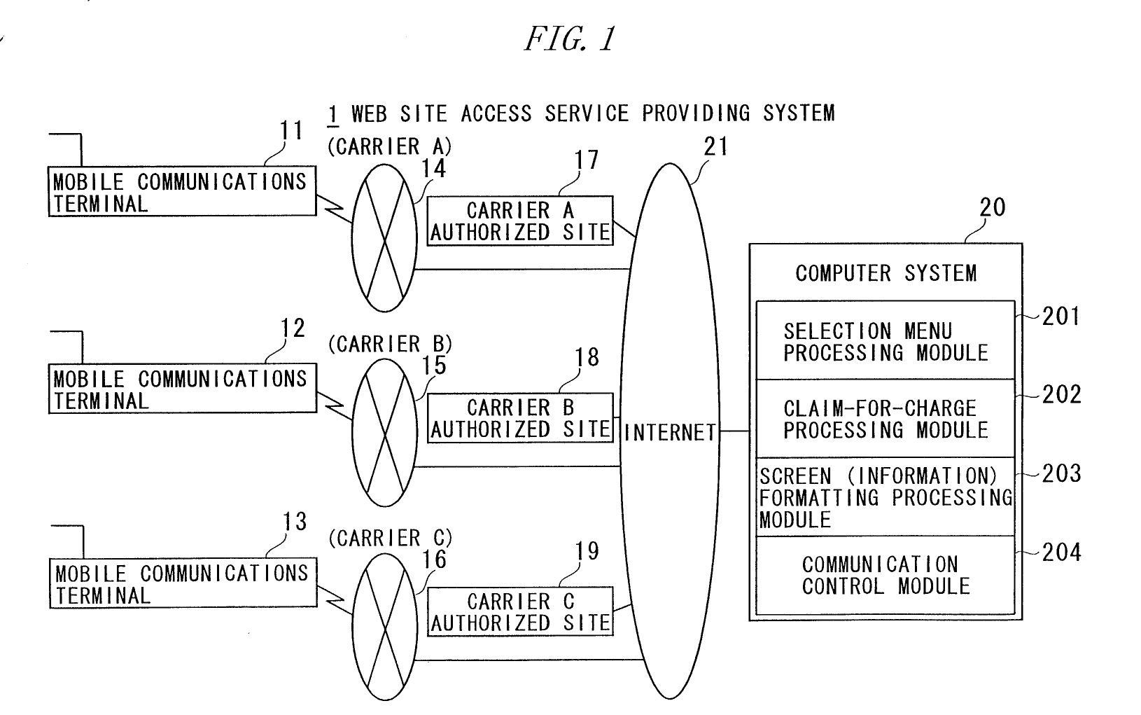

FIG. 1 is a diagram showing a system architecture in embodiment of the present invention. Referring to FIG. 1, a Web site access service providing system 1 is configured by a plurality of mobile communications networks 14, 15, 16 operated by a plurality of mobile common carriers (which will hereinafter be simply called carriers as the case may be) A, B, C, authorized sites (Web sites) 17, 18, 19 administered independently respectively by the plurality of mobile common carriers A, B, C, a computer system (control unit) 20 for controlling how the Web site access service is provided, and an Internet network 21 defined as an IP (Internet Protocol) communications network.

The mobile communications networks 14, 15, 16, the authorized sites 17, 18, 19 of the mobile common carriers A, B, C and the computer system 20, are connected to each other via the Internet 21.

Mobile communications terminals 11, 12, 13 are classified as contract subscriber terminals (including prepaid card system terminals) of the mobile common carriers A, B, C administering the mobile communications networks 14, 15, 16, respectively.

Each of the mobile communications terminals 11, 12, 13, on condition that the terminal implements a content specifying function (Internet connecting function) and a content displaying function of a target Web site (content site), may be any one of a single or composite unit of mobile phone (cellular phone) terminals of i-mode, Ezweb, J-sky and so on, and personal digital assistants (PDAs). Further, as a substitute for each of the mobile communications terminals 11, 12, 13, a communications terminal corresponding to an L-mode may also be used.

Each of the authorized sites 17, 18, 19 independently respectively administered by the mobile common carriers A, B, C is developed strictly on a server (for example, a content distribution server such as an Internet service provider (ISP) etc.) embraced by the Internet 21, thereby providing the mobile communications terminals 11, 12, 13 in response to requests with contents retained (stored) in this server and contents existing where various categories of information hyperlinked with URLs (Uniform Resource Locators).

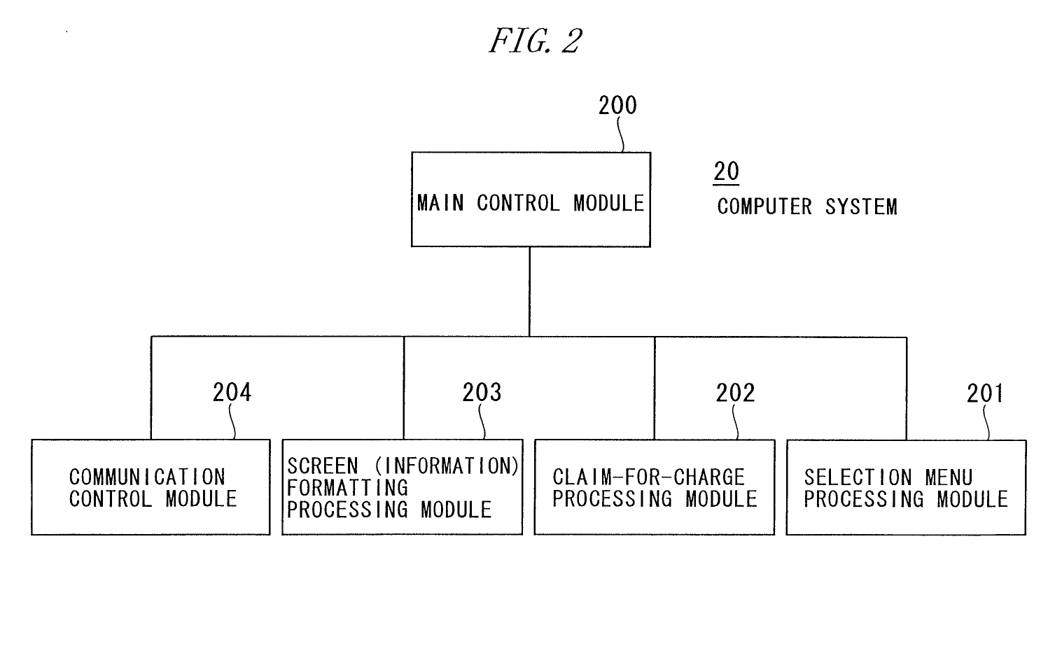

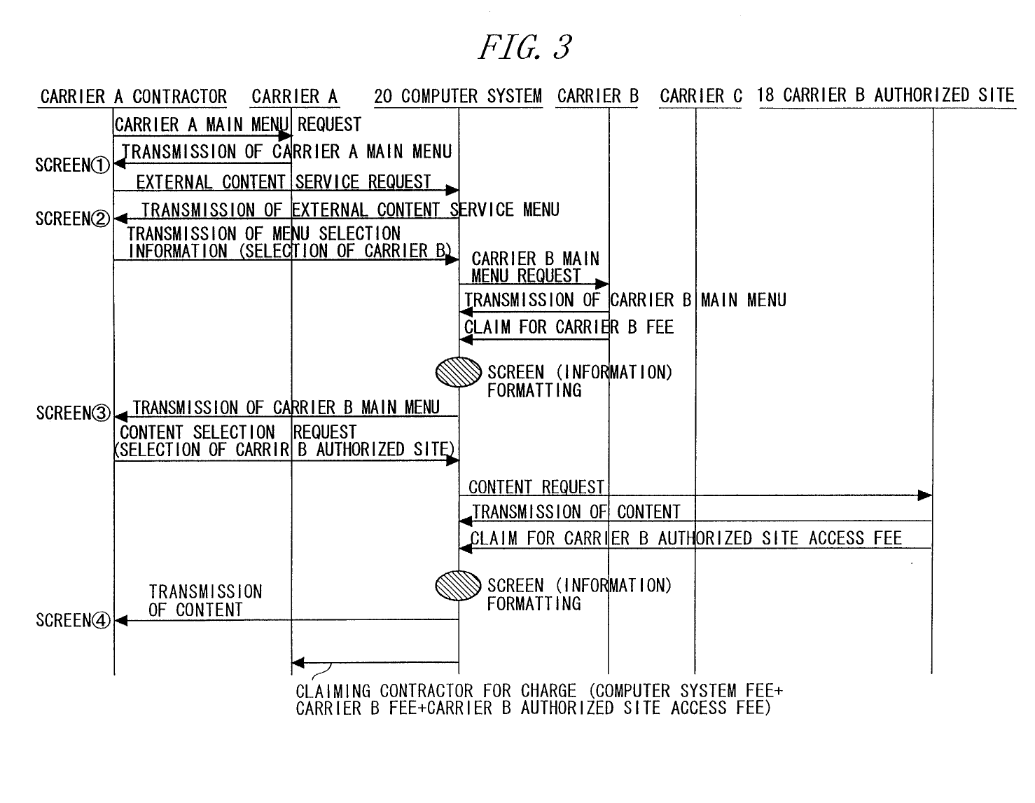

The computer system 20 for controlling the providing of the Web site access service is defined as an agent server possessed by an ASP (Application Service Provider) and so forth. As illustrated in details in FIG. 2, the computer system 20 is constructed of a main control module 200, a selection menu processing module 201, a claim-for-charge processing module 202, a screen (information) formatting processing module 203 and a communications control module 204.

The main control module 200 controls the respective components of the computer system 20. The selection menu processing module 201, in response to service requests given from the mobile communications terminals 11, 12, 13, transmits, back to each of request source mobile communications terminals, a carrier selection menu for selecting mobile communications networks (networks) of mobile common carriers (non-contract carriers) not entering into a contract of connection.

The claim-for-charge processing module 202 calculates a fee of the non-contract carrier, a charge (access fee) for using the authorized site of the non-contract carrier and a fee of the computer system 20, and claims the charges of the mobile common carrier (contract carrier) with which the user has the contract.

The screen (information) formatting processing module 203 converts differences in content expression format (C-HTML (C-HyperText Markup Language) of i-mode, HDML (Handheld Device Markup Language) of Ezweb, MML (Mobile Markup Language) of J-sky and others) between the mobile common carriers and screen restrictions (resolution etc.) of the terminal itself into content formats corresponding to attributes of the mobile communication terminals.

Pieces of existing package software (products) or services (such as [Portal-to-Go] by Oracle Corp., {WebSphere Transcoding Publisher} by IBM and [Quick Access] by E-System Corp. can be applied to a content converting function of this screen (information) formatting processing module 203. These pieces of software and services have a function of auto-judging a type of the mobile phone terminal and an auto mutual converting function of the content expression formats as the content converting function.

The communication control module 204 receives the service requests from the mobile communications terminals 11, 12, 13, transmits the carrier selection menu, accepts the menu requests with respect to the non-contract carriers, and, in addition, transmits and receives the various categories of information.

A program used for the computer system 20 to execute a variety of processes according to the present invention that will hereinafter be described, is downloaded into a hard disk of a hard disk drive from a CD-ROM or a floppy disk by use of an unillustrated CD-ROM drive or floppy disk drive.

Further, the communication control module 204 may download this process execution program into the hard disk via the Internet 21. The process execution program is further downloaded into a main storage unit (unillustrated) from the hard disk, and functions to control the respective units of the computer system 20, thereby executing the processes according to the present invention.

[Operations of Web Site Access Service Providing System]

Next, a variety of operational examples in the web site access service providing system 1 in one embodiment of the present invention shown in FIG. 1, will be explained. Note that an explanation of what is done via the Internet 21 is omitted except when required to particularly specify in the following discussion on the operational examples.

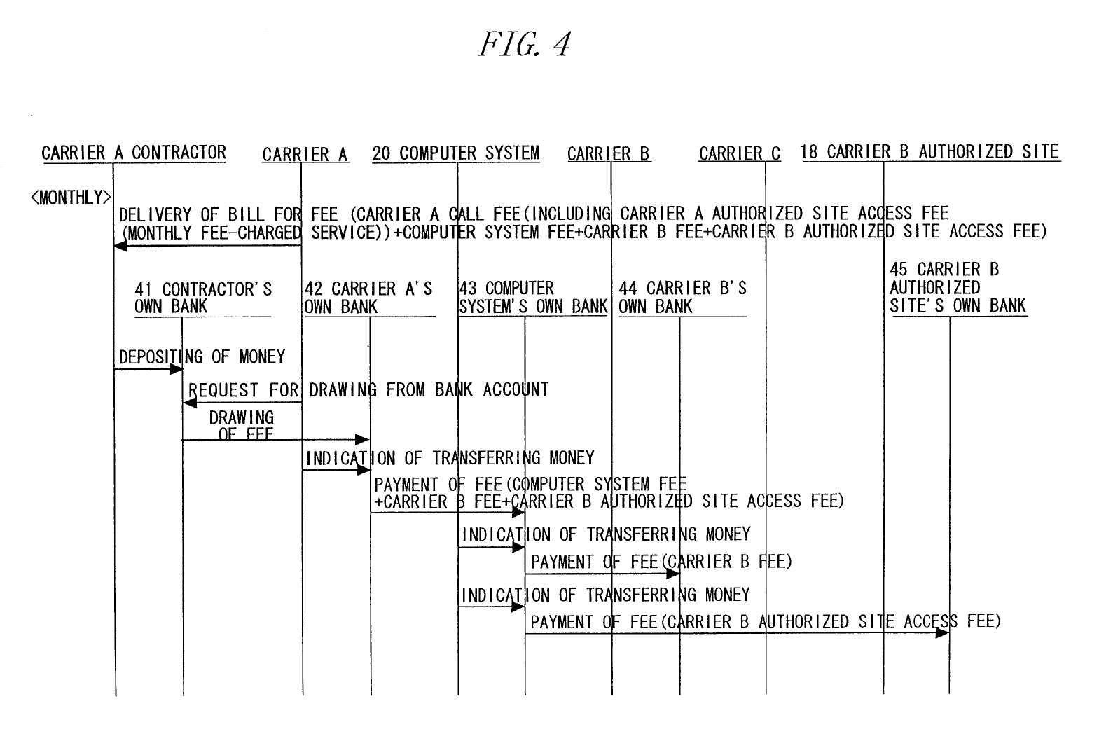

FIG. 3 is an operation sequence diagram showing a basic Web site access service process. FIG. 4 is an explanatory diagram showing a sequence of fee settlement process corresponding to the basic Web site access service process.

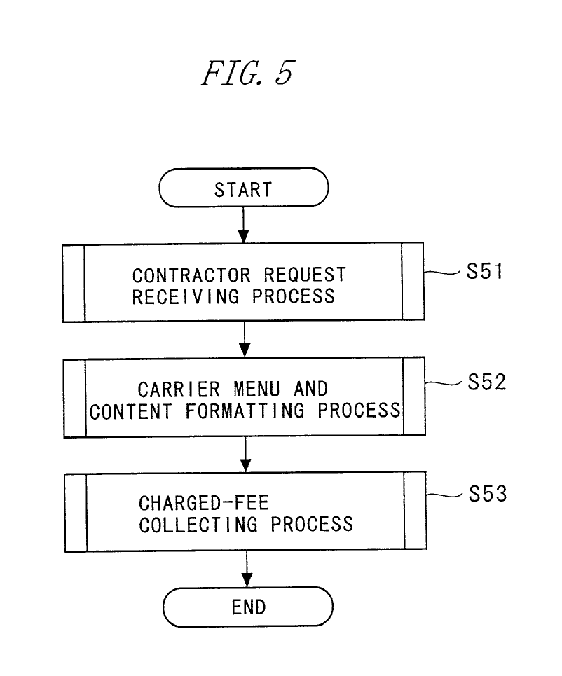

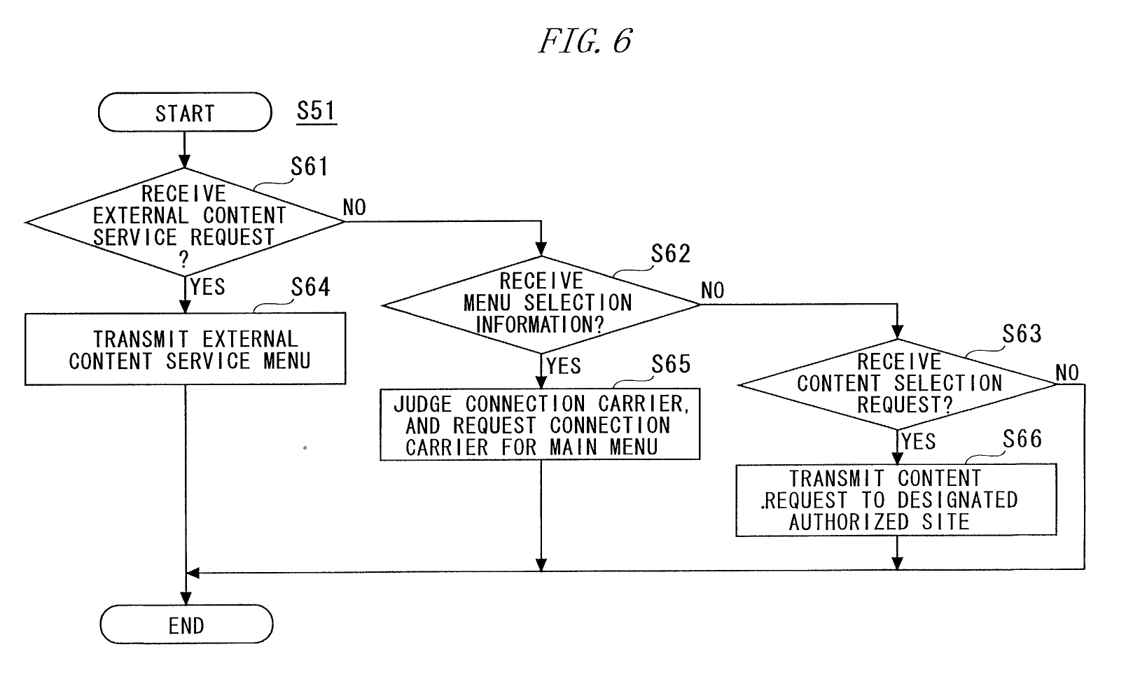

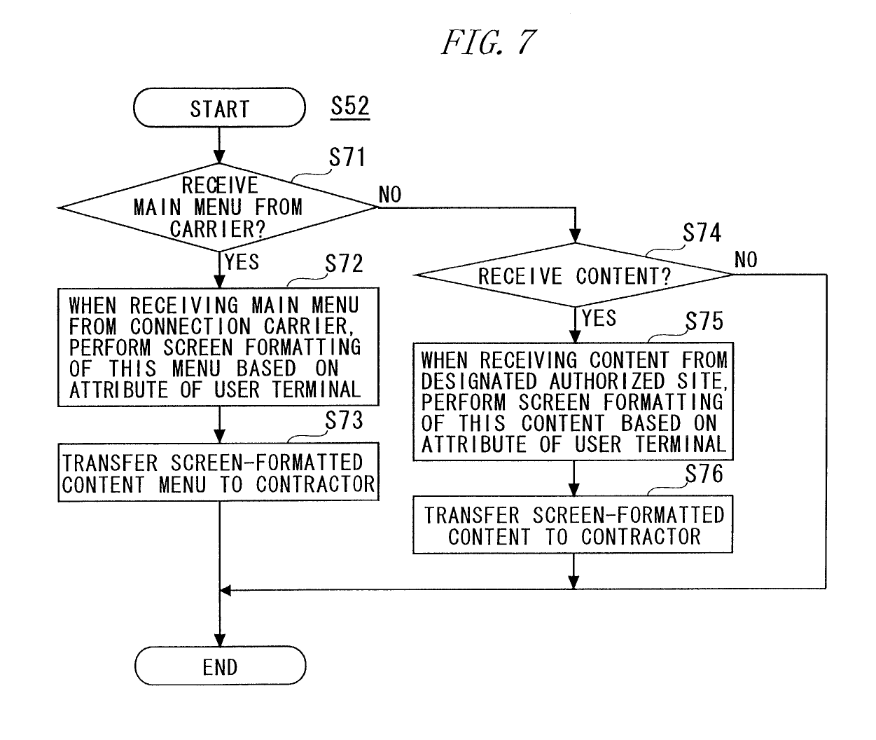

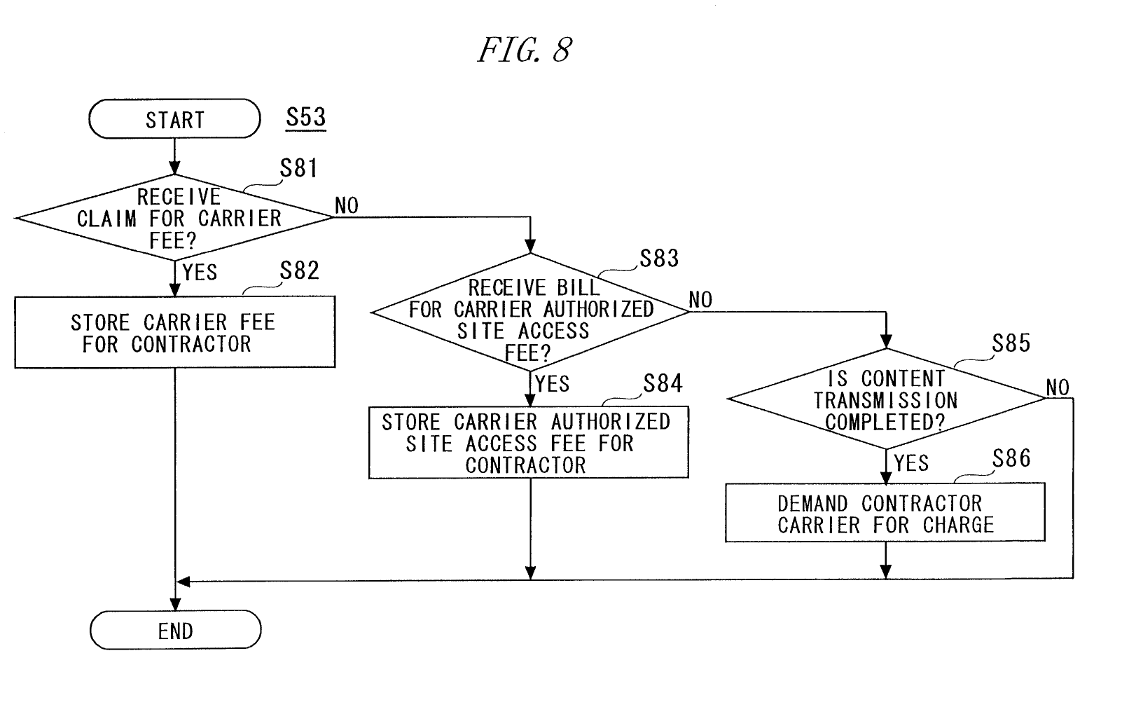

FIGS. 5 to 8 are flowcharts showing the processes by the computer system. FIG. 5 is the flowchart showing the whole processes. FIG. 6 is the flowchart showing the request receiving process from the user who entered into the contract. FIG. 7 is the flowchart showing a carrier menu (content menu) formatting process and a content formatting process. FIG. 8 is the flowchart showing a claimed charge collecting process.

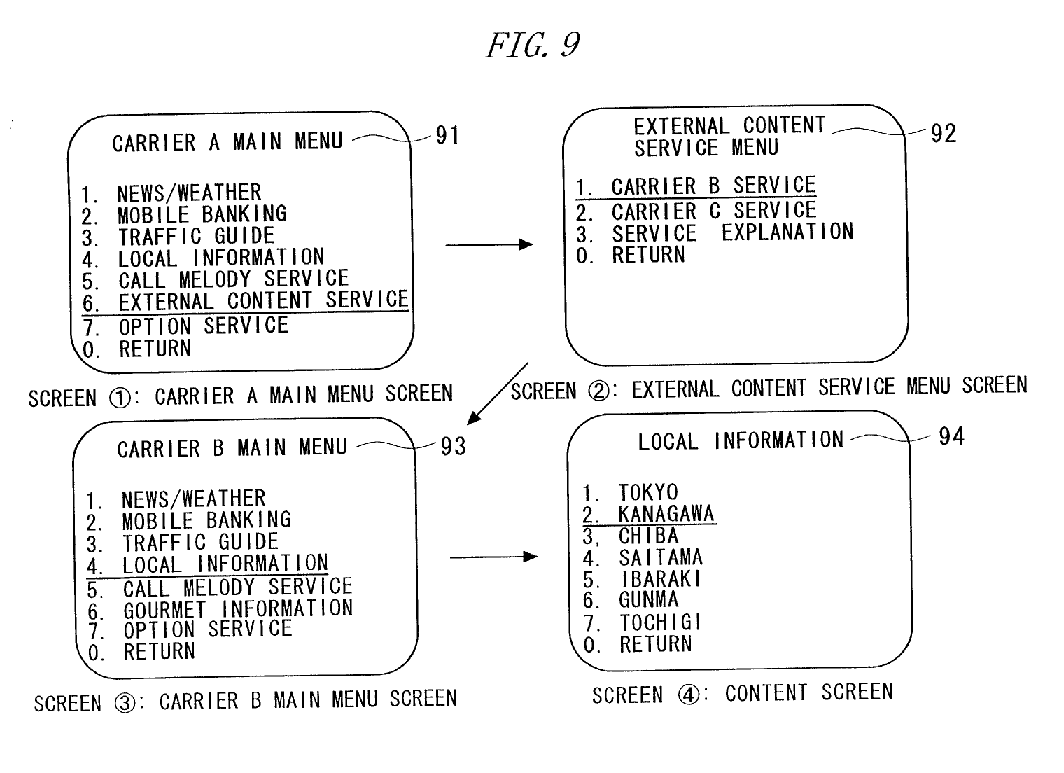

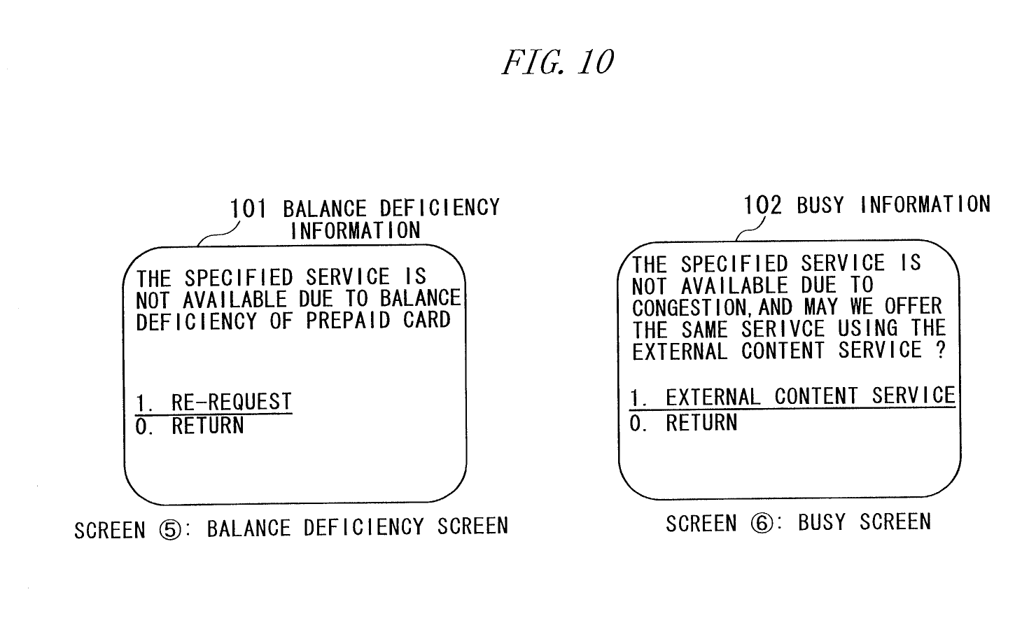

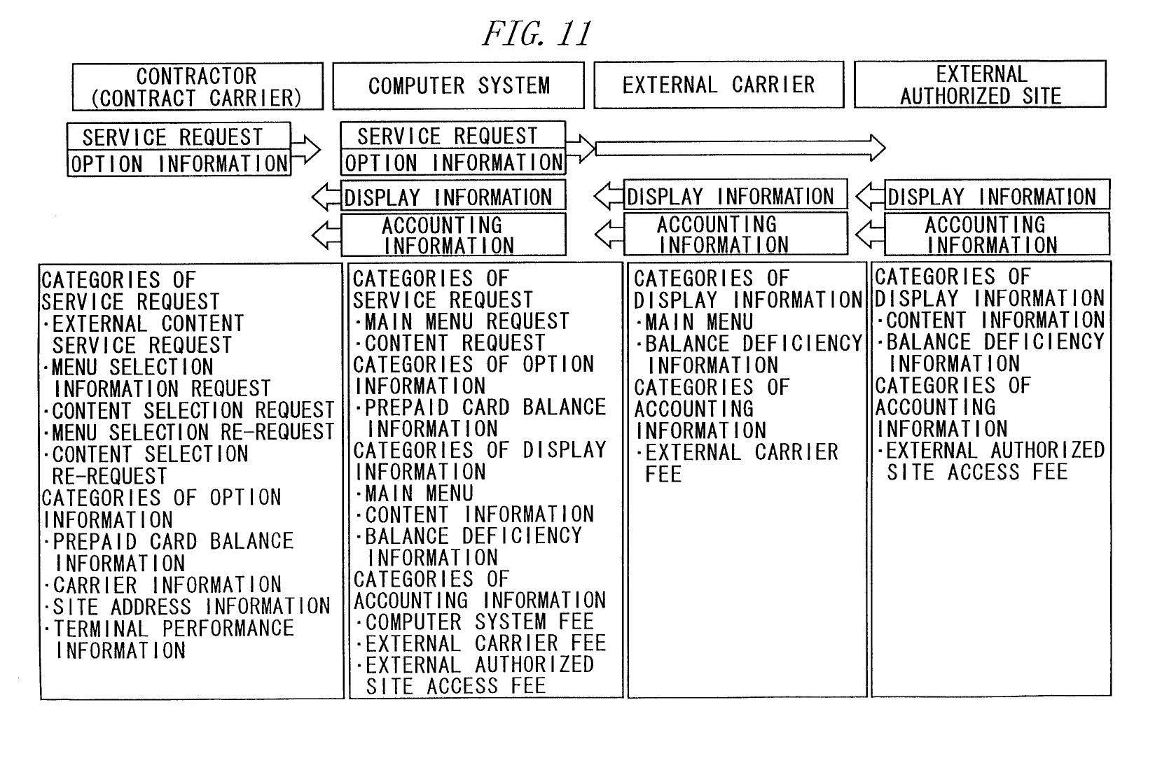

FIGS. 9 and 10 each show examples of screen display on the mobile communication terminal during a service operation. FIG. 11 shows the various categories of information transmitted and received between the carries, the computer system and the carrier authorized sites.

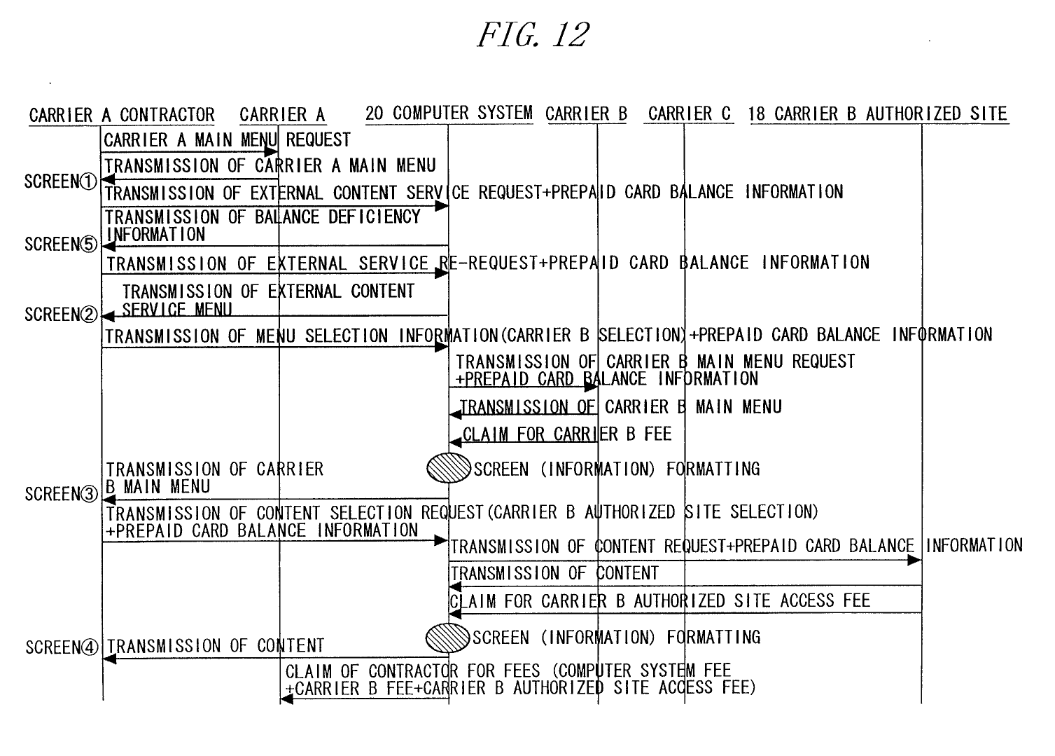

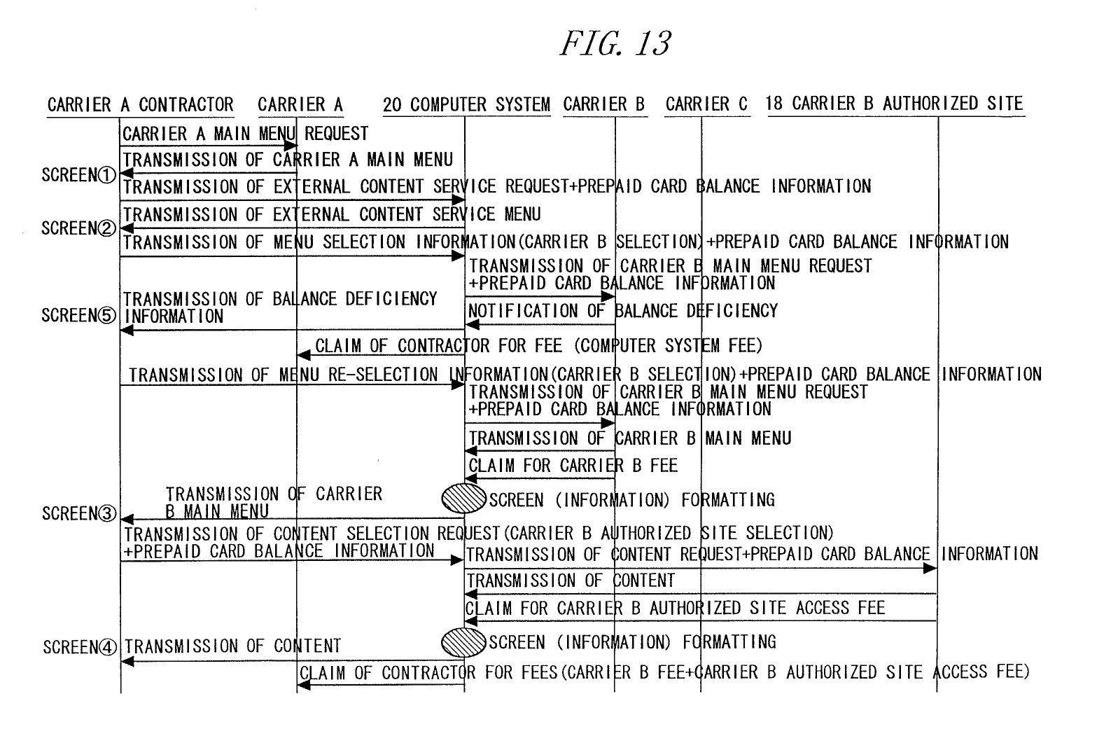

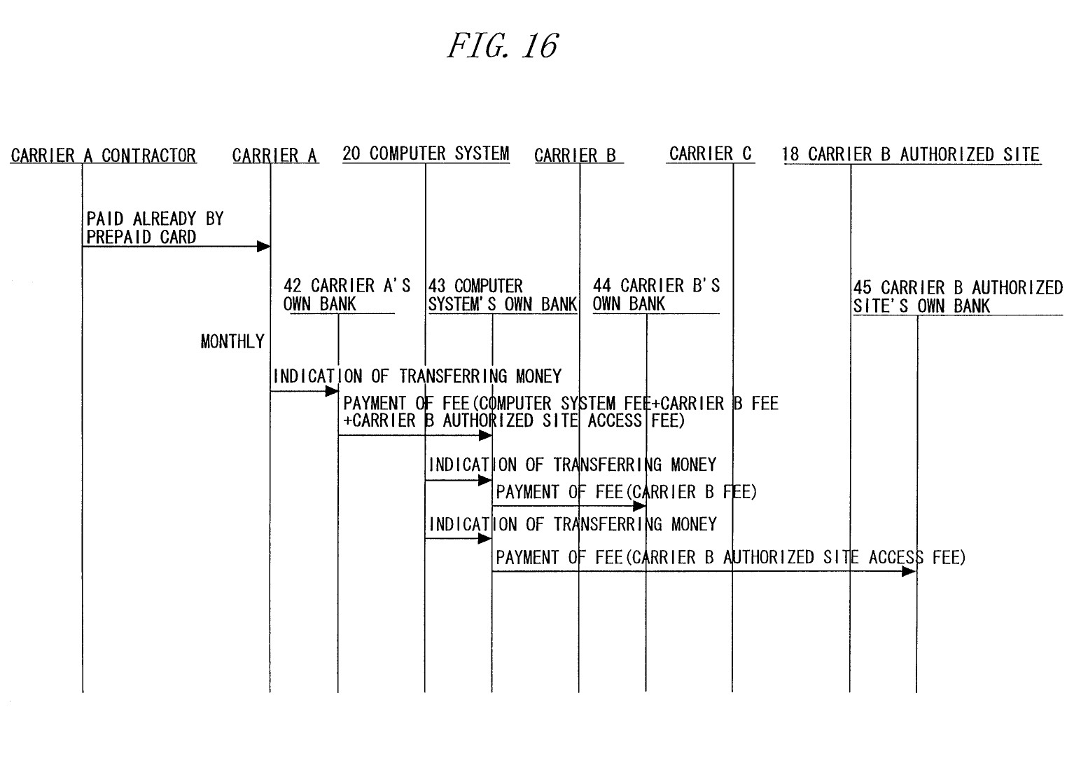

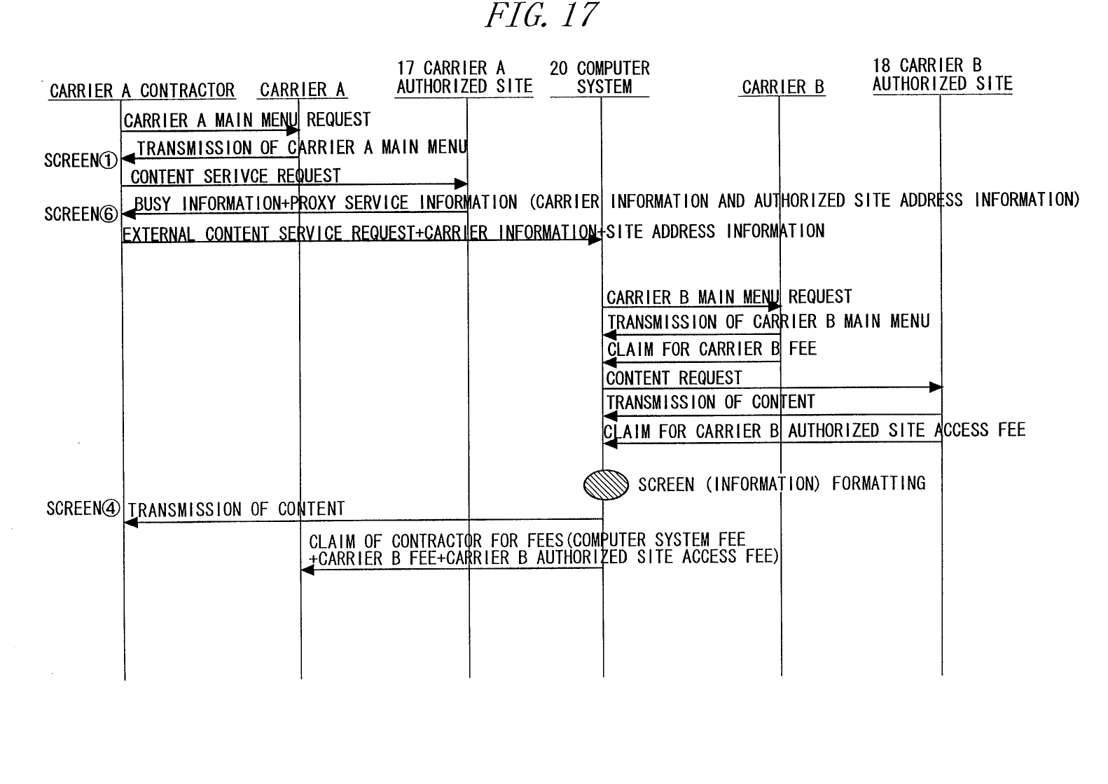

FIGS. 12 through 15 are diagram each showing an operation sequence of a prepaid card system mobile communications terminal oriented process. FIG. 16 is an explanatory diagram showing the fee settlement process corresponding to the prepaid card system mobile communications terminal oriented process. FIG. 17 is a diagram showing an operation sequence when congested on the authorized sites.

(Basic Web Site Access Service Process)

To start with, a basic Web site access service process will be explained referring to FIGS. 1, 3, 5 through 9 and 11 in combination.

A user using the mobile communications terminal 11 and entering into a contract of the carrier A (who is hereinafter be called a contractor in some cases), is unable to have a direct access to the authorized site 18 of the non-contract carrier B.

Such being the case, a service item of [external content service] for accessing the computer system 20 is provided on a carrier A main menu 91 (see a screen \mathring{1} in FIG. 9) displayed on the screen of the mobile communications terminal 11.

The carrier A contractor selects (specifies) the [external content service] from the carrier A main menu 91, and sends an external content service request (one category of the service requests shown in FIG. 11) to the computer system 20.

The computer system 20, upon receiving the external content service request (which is strictly transmitted from the mobile communications terminal 11) from the carrier A contractor, transmits an external content service menu 92 (see a screen \mathring{2} in FIG. 9) to the mobile communications terminal 11 of the contractor.

In this example, the request is given from the carrier A contractor, so that service items of [carrier B service] and [carrier C service] are displayed in the external content service menu 92 on the screen of the mobile communications terminal 11. Note that if requested by a carrier B contractor, the service items of [carrier A service] and [carrier C service] are displayed, and the external content service menu 92 changes corresponding to the request source contractor.

The carrier A contractor selects a predetermined service item from the external content service menu 92 and transmits this service item to the computer system 20. Note that the [carrier B service] is herein selected.

The computer system 20, when receiving the menu selection information (one category of the service requests in FIG. 11) from the carrier A contractor, requests the carrier B administering the mobile communications network 15 for a carrier B main menu 93 (one category of the service requests in FIG. 11).

The carrier B, when receiving the main menu request, transmits the main menu (one category of display information in FIG. 11) managed at the authorized site 18 to the computer system 20, and claims a fee (one category of accounting information in FIG. 11) of the computer system 20.

The computer system 20, upon receiving the carrier B main menu 93, performs screen (information) formatting of the main menu 94 in accordance with terminal attributes of the carrier A contractor, and transmits the carrier B main menu 93 to the mobile communications terminal 11 of the carrier A contractor.

The carrier A contractor, when receiving the carrier B main menu 92 (see a screen \mathring{3} in FIG. 9), selects a content (of the carrier B authorized site 18) from the carrier B main menu 93, and requests the computer system 20 for this content. In the example shown in FIG. 9, an item of [local information] is selected from the carrier B main menu (content menu) 93.

The computer system 20, when receiving a content selection request (one category of the service requests in FIG. 11) from the carrier A contractor, sends a content request (one category of the service requests in FIG. 11) to the carrier B authorized site 18. The carrier B authorized site 18, upon receiving the content request, transmits the corresponding content (one category of the display information in FIG. 11) to the computer system 20.

Further, the carrier B authorized site 18 claims a carrier B authorized site access fee (one category of the accounting information in FIG. 11) of the computer system 20. The computer system 20, when receiving the content of the carrier B authorized site 18, performs the screen (information) formatting of the content in accordance with terminal attributes of the carrier A contractor, and then transmits the formatted content to the mobile communications terminal 11 of the carrier A contractor.

An item of content [local information] 94 of the carrier B authorized site 18 is displayed on the screen of the mobile communications terminal 11 of the carrier A contractor (see a screen \mathring{4} in FIG. 9). Note that in this display example, a content oriented submenu is presented, and, when the contractor selects [Kanagawa], content data hyperlinked thereto are displayed.

The computer system 20, after completing a transmission of the content, demands the carrier A for a sum of the fee of the computer system 20, the fee of the carrier B and the access fee of the carrier B authorized site 18 as a claim for charges (one category of the accounting information in FIG. 11) on the carrier A contractor.

A series of the basic Web site access service processes described above are executed based on the program stored in the computer system 20. This process execution program, as shown in FIG. 5, consists of modules (functions) of a request receiving process S51 from the contractor, a carrier menu/content formatting process S52 and a claimed charge collecting process S53. These functions of the process execution program configure the main control module 200, the selection menu processing module 201, the claim-for-charge processing module 202, the screen (information) formatting processing module 203 and the communication control module 204.

The process execution program, in the from-the-contractor request receiving process S51, functions to judge whether or not the external content service request is received via the mobile communications network from the contractor using the mobile communications terminal (S61), whether or not the menu selection information is received (S62) and whether or not the content selection request is received (S63).

In the case of receiving the menu selection information from the contractor, the program judges which carrier is selected for connection, and requests the connection carrier for the main menu (S65).

In the case of the content selection request from the contract, program functions to transmit the content request to the designated authorized site (S66).

Further, the process execution program, in the carrier menu/content formatting process S52, as shown in FIG. 7, when receiving the main menu from the connection carrier (S71), functions to format the screen (information) with respect to the received main menu in accordance with the attributes of the mobile communications terminal used by the contractor (S72) and to transmit the screen-formatted content menu to the contractor (S73).

When receiving the content from the designated authorized site (S74), the program functions to perform the screen formatting with respect to the received content in accordance with the attributes of the mobile communications terminal used by the contractor (S75). Then, the screen-formatted content is transmitted to the contractor (S76).

Moreover, the process execution program, in the claimed charge collecting process S53, as shown in FIG. 8, when receiving a claim for the carrier fee from the carrier (S81), functions to store the carrier fee with respect to the contractor (S82).

In the case of receiving a claim for the access fee from the carrier authorized site (S83), the program functions to store the carrier authorized site access fee with respect to the contractor (S84).

When completing the content transmission to the contractor (S85), the carrier of the contractor is demanded for a sum of the computer system fee, the carrier fee and the carrier authorized site access fee (S86).

(Fee Settlement Process)

Next, a fee settlement process corresponding to the basic Web site access service process described above will be explained referring to FIGS. 1 and 4 in combination.

The computer system 20, with a series of functions in the basic Web site access service process, demands the carrier A of the contractor for the sum of the computer system fee, the carrier B fee and the carrier B authorized site access fee.

FIG. 4 is the explanatory sequence diagram showing the a fee settlement method carried out per month between the carriers A, B, the computer system 20 and the carrier B authorized site 18 after demanding for the fees. This fee settlement process is executed by way of an extension of the claimed fee collecting process (FIG. 8) of the program in the computer system 20.

The carrier A monthly sends a bill for the fee to the contractor using the mobile communications terminal 11. The bill for the fee contains a carrier A call fee (containing the carrier A authorized site access fee (a fee for the monthly fee-charged service), the computer system fee, the carrier B fee, and the carrier B authorized site access fee.

The contractor receiving the bill for the fee pays the fee for the user to a contractor's own bank 41. The carrier A requests the contractor's own bank 41 to draw the fee from a contractor's account, thereby drawing the fee out of the contractor's own bank 41 into the carrier A's own bank 42.

Next, the carrier A indicates a computer system's own bank 43 to transfer the money to carrier A's own bank 42 in order to pay an amount of money equivalent to the fee claimed by the computer system 20 (which is the sum of the computer system fee, the carrier B fee and the carrier B authorized site access fee) thereby transferring the amount of money equivalent to the claimed fee into the computer system's own bank 43.

The computer system 20 indicates the computer system's own bank 43 to transfer the money into a carrier B's own bank 44 in order to pay an amount of money equivalent to the carrier B fee claimed by the carrier B, thereby transferring the amount of money equivalent to the carrier B fee claimed into the carrier B's own bank 44.

Next, the computer system 20 indicates the computer system's own bank 43 to transfer the money into a carrier B authorized site's own bank 45 in order to pay the amount of money equivalent to the carrier B authorized site access fee claimed by the carrier B authorized site 18, thereby paying the carrier B authorized site access fee to the carrier B authorized site's own bank 45.

With the above processing method executed, the fee settlement between the carrier A, the computer system 20, the carrier B and the carrier B authorized site 18, is implemented between the banks.

(Prepaid Card System Mobile Communications Terminal Oriented Process)

Next, a prepaid card system mobile communications terminal oriented process and a fee settlement process thereof will be described referring to FIGS. 1 and 9 through 16 in combination.

If the contractor uses the prepaid card system mobile communications terminal, the contractor carrier has a piece of information on a prepaid card balance (money left over) of the contractor, and therefore transmits this piece of balance information together with the various categories of service requests from the contractor to the computer system 20.

(1) Given first is an explanation of a process executed if a balance deficiency occurs when making the external content service request from the carrier A contractor using the mobile communications terminal (which is herein the prepaid card system mobile communications terminal) 11 (see FIG. 12).

The computer system 20, when receiving the external content service request from the contractor and a piece of prepaid card balance (money left over) information (one category of option information in FIG. 11), subtracts the computer system fee from the prepaid card balance (remainder).

If thus subtracted value is equal to or less than “0”, the computer system 20 transmits the balance deficiency information (one category of display information in FIG. 11) to the contractor. When the contractor receives this piece of balance deficiency information through the mobile communications terminal 11, balance deficient information 101 is displayed on the screen (see a screen \mathring{5} in FIG. 10).

The contractor exchanges the prepaid card at the mobile communications terminal 11 and selects an item of [re-request] on the balance deficiency information 101 display screen, thereby receiving a continuation of the service.

Subsequent processes in this prepaid card system mobile communications terminal oriented process are substantially the same as those in the basic Web site access service process discussed above except for transmitting and receiving the prepaid balance information.

(2) Next, a process executed if the balance deficiency occurs when the computer system 20 requests the carrier B administering the mobile communications network 15 for the main menu request, will be explained (see FIG. 13).

The computer system 20, when receiving the prepaid card balance information and the menu selection information from the carrier A contractor, subtracts the computer system fee from a value defined as the prepaid card balance information.

The computer system 20 sends the main menu request and the prepaid card balance information (which is herein the value left over after subtracting the computer system fee) to the carrier B.

The carrier B subtracts the carrier B fee from the prepaid card balance information (value) left over after subtracting the computer system fee. If this value is equal to or smaller than “0”, the carrier B notifies the computer system 20 of the balance deficiency through the balance deficiency information.

The computer system 20, when notified of the balance deficiency, transmits the balance deficiency information to the contractor. When the contractor receives the balance deficiency information through the mobile communications terminal 11, the balance deficiency information is displayed on the screen of the mobile communications terminal 11 (see a screen \mathring{5} in FIG. 10).

The computer system 20 demands the contractor carrier A for the computer system fee. The contractor exchanges the prepaid card at the mobile communications terminal, thereby receiving the continuation of the service.

When the contractor selects an item of [re-request] on the balance deficiency display screen of the mobile communications terminal 11 after exchanging the prepaid card, a menu selection information re-request (one category of the service requests in FIG. 11) and the prepaid card balance information are transmitted to the computer system 20 from the contractor.

The computer system 20 sends to the carrier B the main menu request and the prepaid card balance information (in this case, the computer system fee has already been paid, and hence nothing is subtracted therefrom), thereby making it possible to receive the continuous service.

Finally, just when the content is displayed on the mobile communications terminal 11 of the contractor, the computer system 20 demands the contractor carrier A for the carrier B fee and the carrier B authorized site access fee.

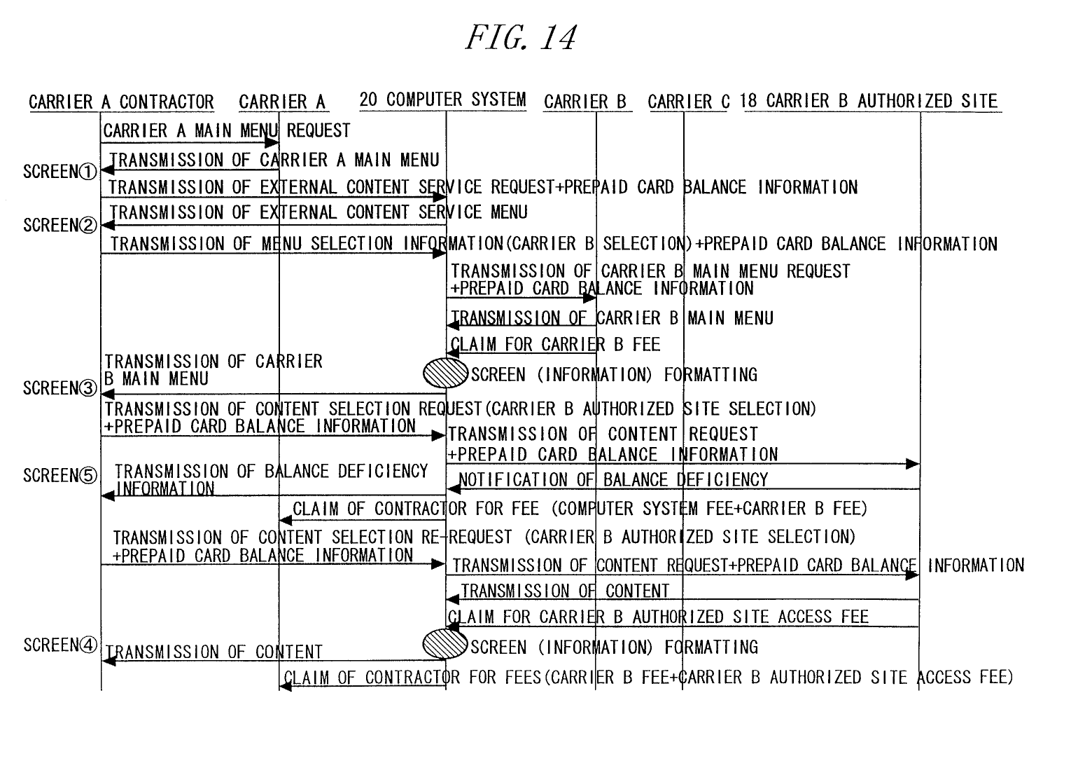

(3) Next, a process executed if the balance deficiency occurs when the computer system 20 requests the carrier B authorized site 18 for a content, will be described (see FIG. 14).

The computer system 20, when receiving the prepaid card balance information and a content selection request from the carrier A contractor, sends to the carrier B authorized site 18 a content request and the prepaid card balance information (which indicates a value left over by subtracting the computer system fee and the carrier B fee).

The carrier B authorized site 18 subtracts the carrier B authorized site access fee from the prepaid card balance information (value) left over by subtracting the computer system fee and the carrier B fee. If this value is equal to or smaller than “0”, the carrier B authorized site 18 notifies the computer system 20 of the balance deficiency.

The computer system 20, when notified of the balance deficiency, transmits the balance deficiency information to the contractor. When the contractor receives the balance deficiency information through the mobile communications terminal 11, the balance deficiency information is displayed on the screen of the mobile communications terminal 11 (see the screen \mathring{5} in FIG. 10).

The computer system 20 demands the contractor carrier A for the computer system fee and the carrier B fee.

When the contractor selects the item of [re-request] on the balance deficiency display screen of the mobile communications terminal 11 after exchanging the prepaid card, a content selection re-request (one category of the service requests in FIG. 11) and the prepaid card balance information are transmitted to the computer system 20 from the contractor.

The computer system 20 sends to the carrier B authorized site 18 the content request and the prepaid card balance information (in this case, the computer system fee and the carrier B fee have already been paid, and hence nothing is subtracted therefrom), thereby making it feasible to receive the continuous service.

Finally, just when the content is displayed on the mobile communications terminal 11 of the contractor, the computer system 20 demands the contractor carrier A for the carrier B authorized site access fee.

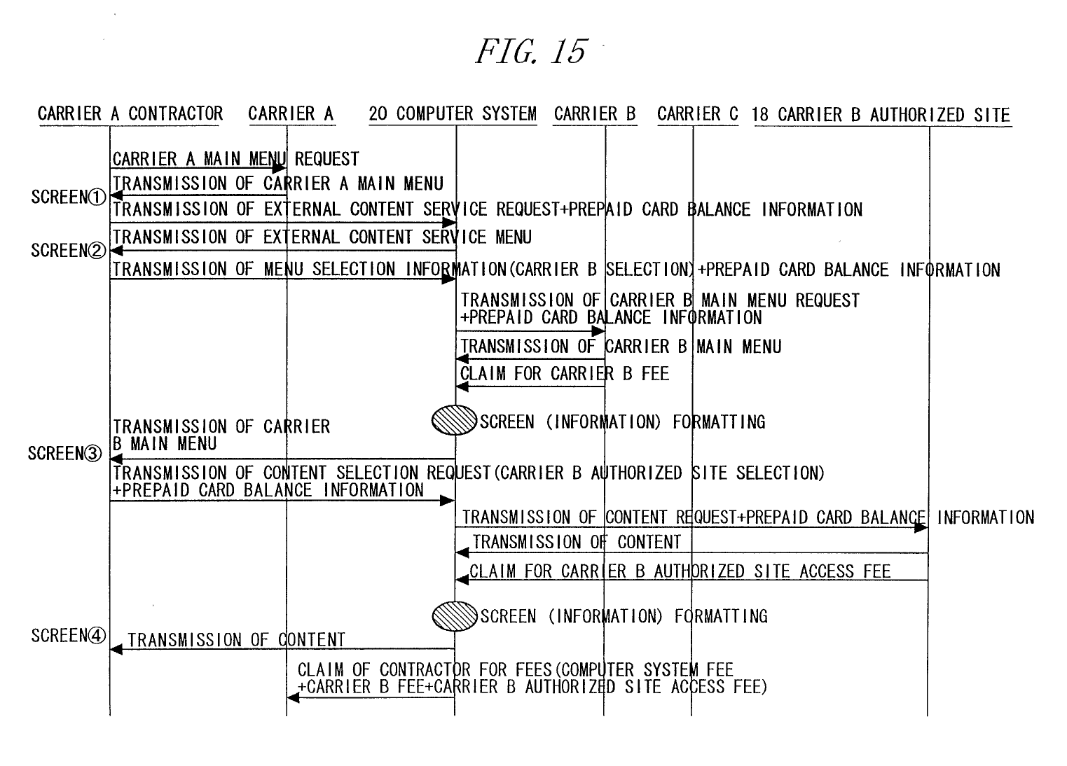

(4) In the prepaid card system mobile communications terminal oriented process, a process executed if the prepaid card balance deficiency does not occur is substantially the same as the basic Web site access service process except for transmitting and receiving the prepaid card balance information between the carrier A contractor, the computer system 20, the carrier B and the carrier B authorized site 18 (see FIG. 15).

(5) Further, the fee settlement method corresponding to the prepaid card system mobile communications terminal oriented process is substantially the same as the fee settlement process corresponding to the basic Web site access service process except that the payment is done with no intermediary of the contractor's own bank 41 because of the carrier A contractor paying the fee to the carrier A by the prepaid card (see FIG. 16).

(Process Executed When Congestion Occurs on Carrier Authorized Site)

Next, a process executed when a congestion occurs on the carrier authorized site will be described with reference to FIGS. 1, 9 through 11 and 17 in combination. Namely, the discussion will be focused on a content provision proxy method involving the use of the external content service when the carrier authorized site encounters the congestion.

When the carrier A contractor requests the carrier A authorized site 17 for a content service from on the main menu 91 on the display screen (the screen \mathring{1} in FIG. 9) of the mobile communications terminal 11, the carrier A authorized site 17 falls into the congestion and therefore sends a piece of busy (BUSY) information and pieces of proxy service information (carrier information and carrier authorized site address information) to the contractor.

At this time, the BUSY information 102 is displayed on a screen \mathring{6} in FIG. 10 of the mobile communications terminal 11 of the contractor. These pieces of BUSY information 102 and proxy service information come under one category of the option information shown in FIG. 11.

The contractor, if desiring for a proxy content service, specifies the [external content service] on the display screen (the screen \hat{6} of the mobile communications terminal 11. With this service specified, an external content service request, the carrier information (on the carrier B in this case) and the site address information (of the carrier B authorized site in this case), are sent to the computer system 20 from the contractor using the mobile communications terminal 11.

The computer system 20, based on the carrier information and the site address information, accesses the carrier B and obtains the main menu of the carrier B. The computer system 20 further accesses the carrier B authorized site 18 from on this menu, then formats the content information obtained, and transmits the formatted content to the contractor.

The computer system 20, after transmitting the content, demands the carrier A of the contractor for the computer system fee, the carrier B fee and the carrier B authorized site access fee.

### [Modified Example]

According to the Web site access service providing system 1 in on e embodiment discussed above, even contents in a foreign language version can be displayed in Japanese by adding a translation function as an option when performing the content screen (information) formatting.

This translation function is set in a way that adds it as option information when the service request is given from the contractor and transmits this item of option information to the computer system 20. The computer system 20, if the content is displayed in a foreign language like English, judges whether the translation is needed or not by collating with the option information, and, if judged to be translated, translates the content.

This translation service is conducted by the computer system, and hence a service fee is added to the computer system fee and is demanded of the contractor.

According to the Web site access service providing system, the computer system has the menu for selecting the non-contract carrier, and implements the function of accessing the authorized Web site of the non-contract carrier in response to the user request and the function of transmitting the information obtained by accessing to the user.

The computer system further implements the function of performing the screen (information) formatting corresponding to the attributes of the user's terminal, and the function of calculating the fee of the non-contract carrier, the fee of the authorized Web site of the non-contract carrier and the computer system fee (the Web site access service providing fee) and claiming for these fees.

Moreover, the computer system is capable of switching over the menu for selecting the non-contract carrier by identifying the contract carrier of the user.

Still further, the computer system implements the function of, if the accesses to the authorized Web site from the contract carrier are congested, accepting the access request to the authorized Web site of the non-contract carrier from the user.

This architecture is capable of providing more of service ability owing to the expansion of the service utilizing range of the user and effecting the load sharing on the network.

Further, the accessibility to the Web sites through the carriers provides new profit sources to not only the contract carriers but also the non-contract carriers. Besides, this makes it unnecessary for each of the carriers to configure a new architecture.

Although only a few embodiments of the present invention have been described in detail above, those skilled in the art will readily appreciate that many modifications are possible in the preferred embodiments without departing from the novel teachings and advantages of this invention. Accordingly, all such modifications are intended to be included within the scope of the present invention as defined by the following claims.

What is claimed is:

1. A Web site access service control apparatus comprising:
a module for transmitting a content menu of a Web site provided by a non-contract common carrier of a user to a communications terminal of the user in response to a request given from the user via said communications terminal; and
a module for obtaining content data corresponding to the content menu of the non-contract common carrier selected by the user, and transmitting the content data to said communications terminal.

2. A Web site access service control apparatus according to claim 1, further comprising a module for transmitting, to said communications terminal of the user, a menu in which the non-contact common carrier is arbitrarily selected corresponding to the contract-common carrier of the user.

3. A Web site access service control apparatus according to claim 1, further comprising a module for converting display data in accordance with an attribute of said communications terminal of the user.

4. A Web site access service control apparatus according to claim 3, wherein the attribute of said communications terminal is a content expression format.

5. A Web site access service control apparatus according to claim 1, further comprising a module for making, if accesses to the Web site from the contact common carrier of the user are congested, the user accessible to the same category of Web site administered by the non-contract common carrier in response to a request of the user.

6. A Web site access service control apparatus according to claim 1, further comprising a module for controlling a settlement of fees for user accesses to the Web site administered by the non-contract common carrier.

7. A Web site access service control apparatus according to claim 6, wherein said module for controlling the fee settlement notifies the user's contract common carrier of a fee for accessing the Web site administered by the non-contract common carrier, a fee for operations of the non-contract common carrier and a fee for providing a Web site access service, and makes the contract common carrier collect the fees.

8. A Web site access service control apparatus according to claim 1, further comprising a module for receiving, if said communications terminal is classified as a prepaid card system communications terminal, a piece of balance information corresponding to said communications terminal.

9. A Web site access service control apparatus according to claim 8, further comprising a module for transmitting, to said communications terminal, balance deficiency information containing an item of re-request that can be made.

10. A Web site access service control method comprising:
transmitting a content menu of a Web site provided by a non-contract common carrier of a user to a communications terminal of the user in response to a request given from the user via said communications terminal; and
obtaining content data corresponding to the content menu of the non-contract common carrier selected by the user, and transmitting the content data to said communications terminal.

11. A Web site access service control method according to claim 10, further comprising transmitting, to said communications terminal of the user, a menu in which the non-contact common carrier is arbitrarily selected corresponding to the contract-common carrier of the user.

12. A Web site access service control method according to claim 10, further comprising converting display data in accordance with an attribute of said communications terminal of the user.

13. A Web site access service control method according to claim 10, further comprising making, if accesses to the Web site from the contact common carrier of the user are congested, the user accessible to the same category of Web site administered by the non-contract common carrier in response to a request of the user.

14. A Web site access service control method according to claim 10, further comprising controlling a settlement of fees for user accesses to the Web site administered by the non-contract common carrier.

15. A Web site access service control method according to claim 10, further comprising notifying the user's contract common carrier of a fee for accessing the Web site administered by the non-contract common carrier, a fee for operations of the non-contract common carrier and a fee for providing a Web site access service, and making the contract common carrier collect the fees.

16. A Web site access service control method according to claim 10, further comprising receiving, if said communications terminal is classified as a prepaid card system communications terminal, a piece of balance information corresponding to said communications terminal.

17. A Web site access service control method according to claim 16, further comprising transmitting, to said communications terminal, balance deficiency information containing an item of re-request that can be made.

18. A readable-by-computer recording medium recorded with a program, executed by a computer, comprising:
a step of transmitting a content menu of a Web site provided by a non-contract common carrier of a user to a communications terminal of the user in response to a request given from the user via said communications terminal; and
a step of obtaining content data corresponding to the content menu of the non-contract common carrier selected by the user, and transmitting the content data to said communications terminal.

19. A readable-by-computer recording medium recorded with a program according to claim 18, further comprising a step of transmitting, to said communications terminal of the user, a menu in which the non-contact common carrier is arbitrarily selected corresponding to the contract-common carrier of the user.

20. A readable-by-computer recording medium recorded with a program according to claim 18, further comprising a step of converting display data in accordance with an attribute of said communications terminal of the user.

21. A readable-by-computer recording medium recorded with a program according to claim 18, further comprising a step of making, if accesses to the Web site from the contact common carrier of the user are congested, the user accessible to the same category of Web site administered by the non-contract common carrier in response to a request of the user.

22. A readable-by-computer recording medium recorded with a program according to claim 18, further comprising a step of controlling a settlement of fees for user accesses to the Web site administered by the non-contract common carrier.

23. A readable-by-computer recording medium recorded with a program according to claim 18, further comprising a step of notifying the user's contract common carrier of a fee for accessing the Web site administered by the non-contract common carrier, a fee for operations of the non-contract common carrier and a fee for providing a Web site access service, and making the contract common carrier collect the fees.

24. A readable-by-computer recording medium recorded with a program according to claim 18, further comprising a step of receiving, if said communications terminal is classified as a prepaid card system communications terminal, a piece of balance information corresponding to said communications terminal.

25. A readable-by-computer recording medium recorded with a program according to claim 24, further comprising a step of transmitting, to said communications terminal, balance deficiency information containing an item of re-request that can be made.

26. A program comprising:
a step of transmitting a content menu of a Web site provided by a non-contract common carrier of a user to a communications terminal of the user in response to a request given from the user via said communications terminal; and
a step of obtaining content data corresponding to the content menu of the non-contract common carrier selected by the user, and transmitting the content data to said communications terminal.
